(19) United States
(12) Patent Application Publication
(10) Pub. No.: US 2009/0106111 A1
(43) Pub. Date: Apr. 23, 2009

(54) Method for mobile device application advertisement information collection

(76) Inventors: Todd R. Walk, Colorado Springs, CO (US); Nathanael John Bohlmann, Cedar Rapids, IA (US)

Correspondence Address: Todd Walk, 4766 Sand Mountain Pt, Colorado Springs, CO, 80923, US

(21) Appl. No.: 12/288,534

(22) Filed: Oct. 20, 2008

Related U.S. Application Data
(60) Provisional application No. 60/999,861, filed on Oct. 20, 2007.

(51) Int. Cl. G06Q 30/00

(52) U.S. Cl. 705/14; 705/1

(57) ABSTRACT

A method for obtaining demographic and/or preferences information for the display of targeted advertisements into applications on mobile platforms. The described method has advantages of directly connecting the collected demographic information and preferences to the application in question and allowing any type of demographic or preference information to be requested and collected.

### CROSS-REFERENCE TO RELATED APPLICATIONS

This application claims the benefit of provisional patent application Ser. No. 60/999,861, filed Oct. 20, 2007 by the present inventors.

### BACKGROUND

1. Field of Invention

This invention relates to applications running on mobile devices that have software code for advertising inserted into them and have a method for collecting information on end user advertisement preferences and/or demographic information for the purposes of targeting advertisements.

2. Prior Art

Previous methods for acquiring demographic information for mobile application advertising involved either retrieving that information from a wireless carrier or else some form of questioning an end user before allowing them to access the application for installation on the end user's mobile device. The main issue with accessing wireless carrier information is that the carrier must grant access to this information. Furthermore, they typically do not have access to all the useful information that an advertiser would desire. The problem with requesting the information before allowing application access for installation is that it doesn't create a guaranteed direct connection between the specific application to be run and the demographic information of the end user running the application.

Currently there is no methods in use for allowing an end user to customize their application advertising preferences.

### SUMMARY

A process for collecting end user advertisement preferences and demographic information for advertisements inserted into mobile device applications for the purpose of targeting advertisements.

### DRAWINGS—FIGURES/LISTINGS

FIG. 1: Menu display requesting the end user to select their preferred ad rating.

FIG. 2: Menu display requesting the end user to select their preferred ad format.

FIG. 3: Menu display requesting the end user to select their location.

FIG. 4: Menu display requesting the end user to select their age range.

Listing 1: The 2 major methods from a J2ME Java embodiment.

### DETAILED DESCRIPTION—PREFERRED EMBODIMENT

A basic embodiment of the invention will, right after a mobile device application is first started, display a screen requesting information from the end user. From this screen, demographic and/or advertisement preferences will be captured.

In more detail, components of the basic embodiment of this invention entail:
1) A mobile device capable of executing a J2ME Java mobile device application.
2) A jad and jar file for a J2ME Java mobile device application which contains some method for displaying advertisements to the end user.
3) An additional section of software code added to the application for collecting demographic information and/or advertisement preferences, as displayed in Listing 1.

### Operation

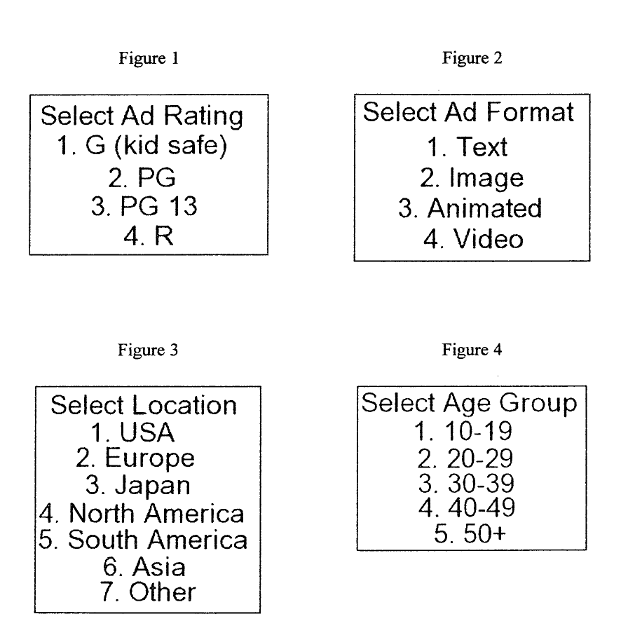

1) The additional section of software code in Listing I for the collection of demographic/preferences information is merged into the application into the first executing application Canvas class. This can either be done before compiling the application or by some means of inserting it (plus some form of support code) after the compilation.
2) displayAdSetup in Listing 1 is executed at the beginning of application execution.
3) It displays the menu screen and then waits for a keystroke to occur. This keystroke is captured by the keyPressed method in Listing 1 and the corresponding setting is fixed.
4) This simple embodiment displays only 4 options as shown from FIG. 1: G rated ads, PG rated ads, PG 13 rated ads, and R rated ads.
5) Now the end user selects 1-4.
6) After this the advertisement display code uses this preference for selecting an advertisement to display to the end user.

### Alternative Embodiments

1) From FIGS. 1-4 and by modifying the code from Listing 1, you can obtain a different and more comprehensive embodiment of the invention. The operation of this embodiment would display 4 different screens of information, one at a time, in the order of FIGS. 1 to 4. In the keyPressed method in Listing 1, the information would then be collected for each screen, while the displayAdSetup method would be extended for displaying the additional menus. This embodiment gives more control to the end user over ad formats and ratings, while also collecting vital demographic information necessary for the good targeting of advertisements.
2) Same as alternative embodiment 1, with the changes of the screen(s) of information instead being customized for different specific advertising requirements, such as requesting if the end user is interested in a specific type of merchandise.
3) Same as the previously described embodiments, but with code added for restoring and saving the collected information into the mobile device's memory. If the information is saved, then it will not need to be sent back to a server and/or the menus shown again.
4) Same effect as previously described embodiments, but with changes in the control scheme and/or display. A simple change is to have a display that can show more items for selection than can fit onto the screen. Additional items can be seen by scrolling or paging the screen to display the extra items. Scrolling or paging can be controlled with defined keys for up and down, and another defined key for selection.
5) Same as previous embodiments, but with changes to Listing 1 allowing execution on mobile platforms other than ones supporting the J2ME Java platform.

### Advantages

A serious issue with displaying advertisements on small mobile technologies (less than a personal computer or laptop) is the lack of access to demographic information. There is also an issue with the inability to allow an end user to control their advertising experience, for example to allow them to switch to a lower data cost form of advertising.

The described method has the advantage of directly connecting the collected demographic information and preferences to the application in question, since said connection can be lost if this information is collected and/or stored in a different way. This Is an important item for effectively being able to target advertisements to an end user. It also gives the ability to request any sort of information, even information that wireless carriers don't normally retain or collect. It also gives the ability for 3rd parties who do not have agreements with wireless carriers to be able to collect demographic information that would normally be unavailable to them.

Even the basic embodiment has major advantages for both the end user and for the distributor. With selecting an advertisement rating, end users can see advertisements more in line to what they will respond to and distributors will not be showing selected advertisements to non-responsive end user groups. If the basic embodiment displays advertising formats instead (FIG. 2), then end users with an unlimited data plan can select image ads and have a richer advertisement experience. Those end users without an unlimited data plan can select text ads and save a significant amount of money compared to viewing image advertisements. Distributors will gain better distribution if end users can select text ads, while the end users that select image ads will gain them better ad rates. A key point in the basic embodiment is that such simple information is often very difficult to obtain by other means.

### CONCLUSIONS, RAMIFICATIONS, AND SCOPE

Accordingly, the reader will see that the basic embodiment allows the collection of demographic information and end user advertising preferences in mobile applications.

Although the description above contains many specificities, these should not be construed as limiting the scope of the embodiment but as merely providing illustrations of some of the presently preferred embodiments. For example, the J2ME Java application code demonstrated in the basic embodiment could instead be, with using the same ideas, easily modified for any other mobile platform.

Thus the scope of the embodiment should be determined by the appended claims and their legal equivalents, rather than by the examples given.

Listing 1

```
protected void keyPressed(int keyCode) {
    if(!gettingKeystroke) return;
    getKeyStates( );
    if(keyCode>=‘1’ && keyCode<=‘4’)
    {
        if(keyCode==‘1’) rating=“G”;
        else if(keyCode==‘2’) rating=“PG”;
        else if(keyCode==‘3’) rating=“PG 13”;
        else if(keyCode==‘4’) rating=“R”;
        gettingKeystroke=false;
    }
}
public boolean displayAdSetup( ) {
    int w=getWidth( );int h=getHeight( );
    g.setFont(Font.getFont(Font.FACE_PROPORTIONAL,Font.-
    STYLE_PLAIN,
        Font.SIZE_MEDIUM));
    int fontHeight=g.getFont( ).getHeight( );
    g.setColor(0,0,0);
    g.fillRect(0,0,w,h);
    g.setColor(255,255,255);
    String str=“Select Ad Format”;
    g.drawString(str,w/2-g.getFont( ).stringWidth(str)/2,0,
        Graphics.LEFT|Graphics.TOP);
    g.setColor(64,64,255);
    g.fillRect(0,fontHeight+5,w,fontHeight*4);
    g.setColor(255,255,0);
    str=“1. G (kid safe)”;
    g.drawString(str,w/2-g.getFont( ).stringWidth(str)/2,fontHeight+5,
        Graphics.LEFT|Graphics.TOP);
    str=“2. PG”;
    g.drawString(str,w/2-g.getFont( ).stringWidth(str)/2,
        fontHeight*2+5,Graphics.LEFT|Graphics.TOP);
    str=“3. PG 13”;
    g.drawString(str,w/2-g.getFont( ).stringWidth(str)/2,
        fontHeight*3+5,Graphics.LEFT|Graphics.TOP);
    str=“4. R”;
    g.drawString(str,w/2-g.getFont( ).stringWidth(str)/2,
        fontHeight*4+5,Graphics.LEFT|Graphics.TOP);
    flushGraphics( );
    gettingKeystroke=true;
    int iter=0;
    while(iter<internetTimeoutIterations*2)
    {
        try { Thread.sleep(100); } catch(java.lang.InterruptedException
        e) { }
        if(!gettingKeystroke) break;
    }
    gettingKeystroke=false;
    if(iter>=internetTimeoutIterations*2);
}
```

We claim:

1. A method of collecting demographic information and/or advertising preferences in a mobile device application running on a mobile device, comprising:
(a) providing said mobile device,
(b) providing an end user of the device,
(c) providing said mobile device application for running on said mobile device,
(d) means for collecting demographic information and/or advertisement preferences during the running of the application from said end user by a display of one or more screens of selectable information at the beginning of execution of the application,
whereby said mobile device application will collect demographic information and/or advertisement preferences directly from said end user.

2. The method of claim 1, further including means for saving the collected demographic information and/or advertisement preferences on said mobile device.

3. The method of claim 1, used so that the collected demographic information and/or advertisement preferences are to be used specifically for targeting of advertisements.
